(19) United States
(12) Patent Application Publication
(10) Pub. No.: US 2002/0189467 A1
(43) Pub. Date: Dec. 19, 2002

(54) Systems and processes for preparing hash browns

(76) Inventors: Dwane Bert Benson, Payette, ID (US); Susan Farnsworth, Fruitland, ID (US); Craig Howard Doan, Weiser, ID (US); James E. Matthews JR., Wexford, PA (US)

Correspondence Address: Regis E. Slutter, BURNS, DOANE, SWECKER & MATHIS, L.L.P., P.O. Box 1404, Alexandria, VA, 22313-1404, US

(21) Appl. No.: 09/866,707

(22) Filed: May 30, 2001

(51) Int. Cl. A23L 1/00

(52) U.S. Cl. 99/352; 99/355

(57) ABSTRACT

Toaster hash brown (THB) potato patties are formed, coated with oil, drained of excess oil, baked in an impingement oven and frozen. The THBs exhibit little or no oil drip when reconstituted.

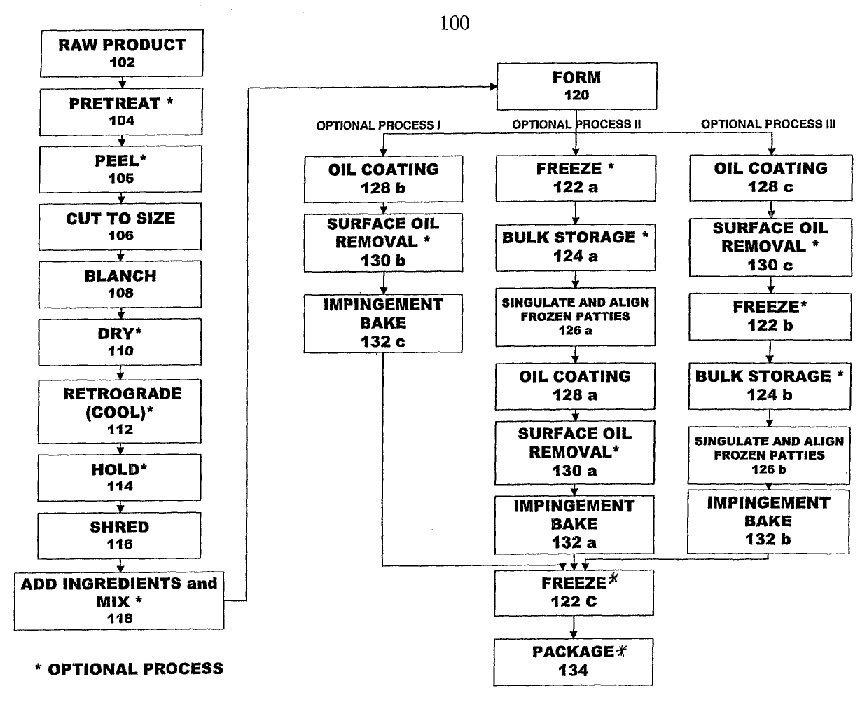

### BACKGROUND OF THE INVENTION

1. Field of the Invention

The present invention relates to systems and processes for preparing hash browns, and more particularly to preparing hash browns which exhibit reduced oil drip when reconstituted.

2. Brief Description of the Related Art

Toaster hash browns (THBs) have been available in many forms. While taking a number of different forms and including a variety of constituent ingredients in their recipes, they have generally been a popular food item. However, THBs have not been fully satisfactory in some respects. For example, prior THBs have exhibited oil drip when they are reconstituted (toasted) in an oven or toaster. As will be readily appreciated, oil drip can be both unappealing to the consumer for a number of reason, and a potential hazard if left in the oven or toaster. For example, presently available THBs exhibit between about 0.15 grams/patty and 1.0 grams/patty of oil drip, as measured by the process described herein.

In order to manage oil drip in prior THBs, it has been a practice in the preparation of THBs to cool the patties at a point along the process, increase the solids in the patty by the addition of potato flakes or other agents, add cellulose gum to the patty, and combinations of these measures. Oil drip, as measured by the process described herein, of THB patties including these additional measures still averages about 0.6 grams per patty, and ranges between about 0.15 and about 1.0 grams per patty.

There therefore remains a need, unaddressed in the prior art, for a THB which exhibits little or no oil drip upon being reconstituted, while still having satisfactory flavor and texture.

### SUMMARY OF THE INVENTION

According to a first exemplary embodiment, a process for preparing a potato patty comprises the steps of coating a potato patty in oil at an oil temperature between about 200 degrees Fahrenheit and about 400 degrees Fahrenheit for a time between about 15 seconds and about 120 seconds, removing excess oil from a surface of the potato patty, heating the potato patty in an impingement oven at an oven temperature of between about 425 degrees Fahrenheit and about 500 degrees Fahrenheit for a time between about 150 seconds and about 630 seconds, and freezing the potato patty.

According to a second exemplary embodiment, a potato patty is prepared by a process comprising the steps of coating a potato patty in oil at an oil temperature between about 200 degrees Fahrenheit and about 400 degrees Fahrenheit for a time between about 15 seconds and about 120 seconds, removing excess oil from a surface of the potato patty, heating the potato patty in an impingement oven at an oven temperature of between about 425 degrees Fahrenheit and about 500 degrees Fahrenheit for a time between about 150 seconds and about 630 seconds, and freezing the potato patty.

According to a third exemplary embodiment, a system for preparing a potato patty comprises means for coating a potato patty in oil at an oil temperature between about 200 degrees Fahrenheit and about 400 degrees Fahrenheit for a time between about 15 seconds and about 120 seconds, means for removing excess oil from a surface of the potato patty, means for heating the potato patty in an impingement oven at an oven temperature of between about 425 degrees Fahrenheit and about 500 degrees Fahrenheit for a time between about 150 seconds and about 630 seconds, and means for freezing the potato patty.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWING

The invention of the present application will now be described in more detail with reference to preferred embodiments of the apparatus and method, given only by way of example, and with reference to the accompanying drawing, in which:

The drawing FIGURE illustrates both systems and processes in accordance with the present invention.

### DESCRIPTION OF PREFERRED EMBODIMENTS

Processes and systems in accordance with the present invention can produce a THB product which exhibits no oil drip when reconstituted in a toaster, while still retaining oil in the patty itself for enhancing both flavor and texture of the patty. The present invention therefore is capable of producing THBs which have significant advantages over prior THBs which suffer from oil drip when reconstituted.

The drawing figure illustrates an exemplary system and process 100 in accordance with the present invention. The drawing figure schematically illustrates both a process flow and a system useful for producing THBs in accordance with the present invention. As schematically illustrated in the drawing figure, processes that are optionally included are identified by an asterisk (*). As will be readily appreciated by one of ordinary skill in the art, the individual steps performed on the product or material which moves through the process define the process, and processes in accordance with the present invention are not restricted to the particular apparatus described herein.

Turning now to the drawing figure, raw potato product is introduced to the process 102. The product is optionally pretreated 104 to heat up the product above the ambient temperature. Pretreatment 104 preferably takes place at a temperature between 100 and 140 degrees Fahrenheit and lasts between 10 and 60 minutes, and preferably lasts between 20 and 40 minutes. The product is optionally peeled 105. The product is cut 106 to a predetermined size. The product then passes to a blanching procedure 108, in which the product is partially cooked and some excess starches are removed from the product. The blanching procedure 108 is done at temperatures between 160 and 195 degrees Fahrenheit, and preferably between 165 and 180 degrees Fahrenheit. The blanching procedure 108 lasts for about 5 to 20 minutes, and preferably for about 10 to 15 minutes. Following the blanching procedure 108, the product is optionally dried 110 for 2 to 10 minutes, and preferably for 5-7 minutes at temperatures up to 180 degrees Fahrenheit, and preferably about 120 to 140 degrees Fahrenheit. The product is optionally cooled 112 at about 32 to 40 degrees Fahrenheit, and preferably at about 34 to 38 degrees Fahrenheit to begin the retrograde process. The product is optionally held 114 at a refrigerated temperature between 32 and 55 degrees Fahrenheit, and preferably about 34 to 38 degrees Fahrenheit for more than 15 minutes, and preferably about 30 to 45 minutes to continue the retrograde process. The refrigerated product is then cut or shredded 116. Other ingredients such as potato flakes and/or cellulose gum are optionally added and mixed 118 with the product. The other ingredients can preferably be added and mixed to the product in less than two minutes.

The product is formed 120 into a patty of the desired shape. The patties are preferably shaped to easily fit into a conventional toaster slot. The patties are preferably approximately 60 grams or less so that they can be lifted by a toaster mechanism. Examples of preferred machines that are useful in forming the product into patties are the Koppens type, Model KN-400 or the Idaho Steel type Model LR-20.

After the products are formed into patties 120, they are optionally frozen 122a at temperatures less than 0 degrees Fahrenheit for preferably not more than 15 minutes. The products are optionally held in bulk storage 124a at temperatures below 0 degrees Fahrenheit, and preferably below −10 degrees Fahrenheit, after which the products are singulated and aligned 126a for further processing.

The product is preferably coated with oil 128a,b,c. The preferred method of coating the product with oil is to deep fry the product for 15 to 120 seconds in a vegetable oil parfry at a temperature ranging from 200 to 400 degrees Fahrenheit. Preferably, the product will be deep fried for between 30 and 45 seconds at a temperature of about 350 to 360 degrees Fahrenheit. After the product has been coated with oil 128a,b,c, the product passes to a surface oil removal device, in which oil is preferably removed 130a,b,c from the top and/or bottom surfaces of the patty. During oil removal the temperature is preferably greater than 200 degrees Fahrenheit, and most preferably between 250 and 300 degrees Fahrenheit.

After the excess oil has been removed 130a,b,c, the products are optionally frozen 122b and optionally held in bulk storage 124b. The products are then singulated and aligned 126b for further processing.

The product preferably passes into an impingement oven to be heated or impinged 132a,b,c. As will be readily appreciated by one of ordinary skill in the art, an impingement oven can be characterized by the use of a gas, preferably air, which is heated above the temperature of the product that the oven is acting on, and injected, blown, or otherwise imparted with a relatively high velocity at or onto the product. The air flow in the impingement oven is preferably in the range of 1500-8000 feet/minute, and most preferably between 5500 and 6500 feet/minute.

Heat is transferred from the gas to the product during the impinging 132a,b,c. The product is preferably heated in the impingement oven for 150 to 630 seconds, and most preferably heated for 210 to 360 seconds. The temperature in the impingement oven is preferably 425 to 500 degrees Fahrenheit, and most preferably between 450 and 475 degrees Fahrenheit. An impingement oven with a cool floor design is preferred to prevent smoking oil.

After the product has been impinged 132a,b,c, the products are preferably frozen 122c and packaged 134 for distribution and/or sale.

Table 1 provides details of exemplary embodiments of a system and process in accordance with the present invention.

TABLE 1

| | Action | Time | Temp. (° F.) | Exemplary | |
|---|---|---|---|---|---|
| Step | (Preferred) | (Preferred) | (Preferred) | Details | Optional |
| 102 | Add raw | n/a | ambient | Off cuts from | No |
| | potatoes | | | FF processes | |
| | | | | can be used | |
| 104 | Pretreat | 10-60 min | 100-140 | none | Yes |
| | | (20-40 min) | | | |
| 105 | Peel | n/a | n/a | none | Yes |
| 106 | Cut to size | n/a | n/a | none | No |
| 108 | Blanch | 5-20 min | 160-195 | none | No |
| | | (10-15 min) | (165-180) | | |
| 110 | Dry | 2-10 min | ambient-180 | none | Yes |
| | | (5-7 min) | (120-140) | | |
| 112 | Retrograde | until temp. | 32-40 | none | Yes |
| | (cool) | is reached | (34-38) | | |
| 114 | Hold | >15 min | 32-55 | none | Yes |
| | | (30-45 min) | (34-38) | | |
| 116 | Shred | n/a | n/a | none | No |
| | potato | | | | |
| | pieces | | | | |
| 118 | Add | <2 min | n/a | none | Yes |
| | ingredients | | | | |
| | and mix | | | | |
| 120 | Form | n/a | n/a | Koppens type, | No |
| | patties | | | Model KN-400 | |
| | | | | or Idaho Steel | |
| | | | | Type Model | |
| | | | | LR-20 | |
| 122 | Freeze | until temp | <0 | none | Yes |
| a, b, c | patties | is reached | | | |
| | | (<15 min) | | | |
| 124 | Bulk | n/a | <0 | none | Yes |
| a, b | Storage | | (−10) | | |
| 126 | Singulate | n/a | n/a | none | No |
| a, b | and Align | | | | |
| | Patties | | | | |
| 128 | Oil | 15-120 sec | 200-400 | Deep fry is | No |
| a, b, c | Coating | (30-45 sec) | (350-360) | preferred | |
| | (deep fry) | | | method | |
| 130 | Remove | n/a | >200 | none | Yes |
| a, b, c | excess | | (250-300) | | |
| | surface oil | | | | |
| 132 | Impinge | 200-630 sec | 425-500 | Cool floor | No |
| a, b | Bake | (240-360 sec) | (450-475) | design | |
| | | | | preferred to | |
| | | | | prevent | |
| | | | | smoking oil. | |
| 132 | Impinge | 150-570 sec | 425-500 | Airflow is | No |
| c | Bake | (210-300 sec) | (450-475) | 1500-8000 fpm | |
| | | | | (5500-6500 fpm) | |
| 134 | Package | n/a | n/a | none | Yes |

In Table 1, “n/a” indicates that the specified parameter is not applicable for that step.

THB patties prepared in accordance with the present invention exhibit little or no oil drip. In the context of the present invention, oil drip is measured by a preferred oil measurement procedure or protocol.

A preferred procedure for measuring oil drip uses a Wells 4 Slice Toaster (model T-4C, institutional, 208 V), a scale capable of reading to the nearest 0.01 gram, a piece of aluminum foil, a tissue, and 4 THB patties. The oil drip test preferably comprises removing the stainless steel tray from the bottom of the toaster. A piece of aluminum foil is preferably cut to fit under the toaster with ample border. The dial knobs on the toaster are preferably set at the darkest level. The toaster is preferably run through at least one heating cycle without a product inside to equilibrate the toaster for testing. The aluminum foil is preferably tared and placed under the toaster. The THB patties are preferably tapped together to knock off excess crumbs before they are placed in the toaster. THB patties are preferably placed in each toaster slot standing vertically. The toaster knobs are preferably depressed to start heating.

The THB patties are preferably heated for four minutes and thirty seconds. A stop watch or timer is preferably used to measure the time the patties are heated. The product will pop up before the time is completed and the operator will preferably depress the knobs down to finish the time. The operator will preferably stop the test by manually pulling the knobs up when the heating time is completed.

The THB patties are preferably allowed to set in the toaster for one minute after popping up to allow for further oil drip. The patties are preferably removed from the toaster and discarded. The aluminum foil is preferably removed from under the toaster and the amount of oil drip is weighed. The weight of the oil drip is preferably recorded. Operators are preferably cautious in handling the hot toaster.

An absorbent tissue is preferably tared on the scale. The toaster is preferably unplugged and turned on one side. The tissue is preferably used to collect oil from the slanted metal slots and the flat underside of the toaster. The oil on the tissue is preferably weighed on the scale. The weight of the oil is preferably recorded. The weight of the oil on the aluminum foil is preferably added to the weight of the oil collected on the tissue to determine the total weight of the oil drip.

### EXAMPLES

As demonstrated by the examples provided herein, the addition of potato flake, the addition of cellulose gum, and performing the retrograde process, had no effect on oil drip. This indicates that the minimized oil drip achieved in the examples is attributable to the combination of steps in accordance with the present invention, and not to the presence or absence of these additional steps.

CHART OF EXAMPLES

| | | Potato | Cellulose | | | Oil Drip |
|---|---|---|---|---|---|---|
| Example | Potato | Flakes | Gum | Dry | Retro-grade | Results |
| 1 | X | X | X | No | X | 0.0 |
| 2 | X | X | No | No | X | 0.0 |
| 3 | X | No | No | No | X | 0.0 |
| 4 | X | No | No | No | No | 0.0 |

### Example 11

THB potato patties were prepared as described above. Retrograde is a change of starch from a water soluble form to a water insoluble form. The process included reducing the temperature to speed the retrograde process. In addition to raw potato product, potato flake and cellulose gum were added. Oil drip, as measured by the protocol described above, was 0.0 grams/patty.

### Example 2

Same as Example 1, but only potato flake was added. Oil drip, as measured by the protocol described above, was 0.0 grams/patty.

### Example 3

Same as Example 1, but neither potato flake nor cellulose was added. Oil drip, as measured by the protocol described above, was 0.0 grams/patty.

### Example 4

Same as Example 3, but the process did not include the retrograde process. Oil drip, as measured by the protocol described above, was 0.0 grams/patty.

While the invention has been described in detail with reference to preferred embodiments thereof, it will be apparent to one skilled in the art that various changes can be made, and equivalents employed, without departing from the scope of the invention.

What is claimed is:

1. A process for preparing a potato patty comprising the steps of:
coating a potato patty in oil at an oil temperature between about 200 degrees Fahrenheit and about 400 degrees Fahrenheit for a time between about 15 seconds and about 120 seconds;
removing excess oil from a surface of the potato patty;
heating the potato patty in an impingement oven at an oven temperature of between about 425 degrees Fahrenheit and about 500 degrees Fahrenheit for a time between about 150 seconds and about 630 seconds; and
freezing the potato patty.

2. A process in accordance with claim 1, wherein said step of heating in an impingement oven is for between 210 seconds and 360 seconds.

3. A potato patty prepared by a process comprising the steps of:
coating a potato patty in oil at an oil temperature between about 200 degrees Fahrenheit and about 400 degrees Fahrenheit for a time between about 15 seconds and about 120 seconds;
removing excess oil from a surface of the potato patty;
heating the potato patty in an impingement oven at an oven temperature of between about 425 degrees Fahrenheit and about 500 degrees Fahrenheit for a time between about 150 seconds and about 630 seconds; and
freezing the potato patty.

4. A potato patty prepared by a process in accordance with claim 3, wherein said step of heating in an impingement oven is for between 210 seconds and 360 seconds.

5. A system for preparing a potato patty comprising:
means for coating a potato patty in oil at an oil temperature between about 200 degrees Fahrenheit and about 400 degrees Fahrenheit for a time between about 15 seconds and about 120 seconds;
means for removing excess oil from a surface of the potato patty;
means for heating the potato patty in an impingement oven at an oven temperature of between about 425 degrees Fahrenheit and about 500 degrees Fahrenheit for a time between about 150 seconds and about 630 seconds; and
means for freezing the potato patty.

6. A system in accordance with claim 5, wherein said step of heating in an impingement oven is for between 210 seconds and 360 seconds.
